(19) United States
(12) Patent Application Publication
(10) Pub. No.: US 2020/0298350 A1
(43) Pub. Date: Sep. 24, 2020

(54) ELECTRONIC DEVICE MANUFACTURING METHOD, ELECTRONIC DEVICE, ELECTRONIC APPARATUS, AND VEHICLE

(71) Applicant: SEIKO EPSON CORPORATION, Tokyo (JP)

(72) Inventor: Hideaki KURITA, Tatsuno-machi (JP)

(21) Appl. No.: 16/824,197

(22) Filed: Mar. 19, 2020

(30) Foreign Application Priority Data
Mar. 22, 2019 (JP) 2019-054301

(51) Int. Cl. B23K 35/40

(52) U.S. Cl. CPC B23K 35/40

(57) ABSTRACT

An electronic device manufacturing method includes mounting an electronic component on a base, placing a lid on the base, and bringing a roller electrode to come into contact with the lid at a contact position overlapping a region where the base and the lid are welded inside an outer edge of the lid in a plan view, and bonding the lid to the base by seam welding.

The present application is based on, and claims priority from JP Application Serial Number 2019-054301, filed Mar. 22, 2019, the disclosure of which is hereby incorporated by reference herein in its entirety.

### BACKGROUND

### 1. Technical Field

The present disclosure relates to an electronic device manufacturing method, an electronic device, an electronic apparatus, and a vehicle.

### 2. Related Art

In an electronic device such as a quartz crystal vibrator or a gyro sensor, an electronic component such as a vibrator element is generally contained in a package. The package includes a base on which the electronic component is mounted and a lid bonded to the base, and a space for containing the electronic component is formed therebetween. For example, seam welding is used for bonding the base and the lid, as disclosed in JP-A-8-274208. In JP-A-8-274208, an annular seal frame is previously soldered to a ceramic package, and the seal frame and a metal lid are seam-welded. In the seam welding, a roller electrode comes into pressure contact with an edge of the metal lid.

In a welding method described in JP-A-8-274208, since a contact position of the metal lid with the roller electrode is the outermost position of the metal lid, a difference between a length of a path of a current flowing from the contact position toward an inner peripheral edge of a portion to be welded and a length of a path of a current flowing toward an outer peripheral edge of the portion is large. Accordingly, in the welding method of JP-A-8-274208, a variation of the current in the portion to be welded increases, and as a result, there is a problem that welding unevenness occurs. Here, when there is too little current contributing to the welding, melting is insufficient, and meanwhile, when too much current contributes to the welding, a void is generated. In either case, there is a possibility that airtightness of bonding is reduced.

### SUMMARY

An electronic device manufacturing method according to an aspect of the present disclosure includes mounting an electronic component on a base, placing a lid on the base, and bringing a roller electrode to come into contact with the lid at a contact position overlapping a region where the base and the lid are welded inside an outer edge of the lid in a plan view, and bonding the lid to the base by seam welding.

An electronic device according to an aspect of the present disclosure includes an electronic component, a base on which the electronic component is mounted, and a lid welded to the base in a state in which the electronic component is contained between the base and the lid, wherein a surface of the lid opposite to the base forms a shape such that a distance from the base is the maximum inside an outer edge of the lid in a portion overlapping a region where the base and the lid are welded in a plan view.

### BRIEF DESCRIPTION OF THE DRAWINGS

FIG. 1 is a plan view illustrating an electronic device according to a first embodiment.

FIG. 2 is a cross-sectional view taken along line II-II in FIG. 1.

FIG. 3 is a cross-sectional view illustrating a shape of a lid according to the first embodiment.

FIG. 4 is a diagram illustrating a flow of an electronic device manufacturing method.

FIG. 5 is a cross-sectional view illustrating a state before pressing when the lid is manufactured by the processing.

FIG. 6 is a cross-sectional view illustrating a state when performing the processing when the lid is manufactured by the processing.

FIG. 7 is a cross-sectional view illustrating an arrangement state of each member during a component mounting step.

FIG. 8 is a plan view illustrating a positional relationship between a base and the lid during a lid placing step.

FIG. 9 is a cross-sectional view illustrating an outline of seam welding during a bonding step.

FIG. 10 is a view illustrating a state of a current flowing from the lid toward the base during the seam welding in the first embodiment.

FIG. 11 is a view illustrating a state of a current flowing from the lid toward the base during seam welding of related art.

FIG. 12 is a cross-sectional view illustrating a shape of a lid according to a second embodiment.

FIG. 13 is a cross-sectional view illustrating a shape of a lid according to a third embodiment.

FIG. 14 is a cross-sectional view illustrating a shape of a lid according to a fourth embodiment.

FIG. 15 is a perspective view schematically illustrating a configuration of a mobile type or notebook type personal computer that is an example of an electronic apparatus.

FIG. 16 is a plan view schematically illustrating a configuration of a smartphone that is an example of the electronic apparatus.

FIG. 17 is a perspective view schematically illustrating a configuration of a digital still camera which is an example of the electronic apparatus.

FIG. 18 is a perspective view schematically illustrating an automobile which is an example of a vehicle.

### DESCRIPTION OF EXEMPLARY EMBODIMENTS

Hereinafter, preferred embodiments of the present disclosure will be described with reference to the accompanying drawings. In the drawings, dimensions or scales of the respective portions are different from actual dimensions or scales as appropriate, and some portions are schematically illustrated for easy understanding. Further, the scope of the present disclosure is not limited to the embodiments unless stated otherwise to limit the present disclosure in particular.

### A. Electronic Device

### A1. First Embodiment

### A1-1. Outline of Electronic Device

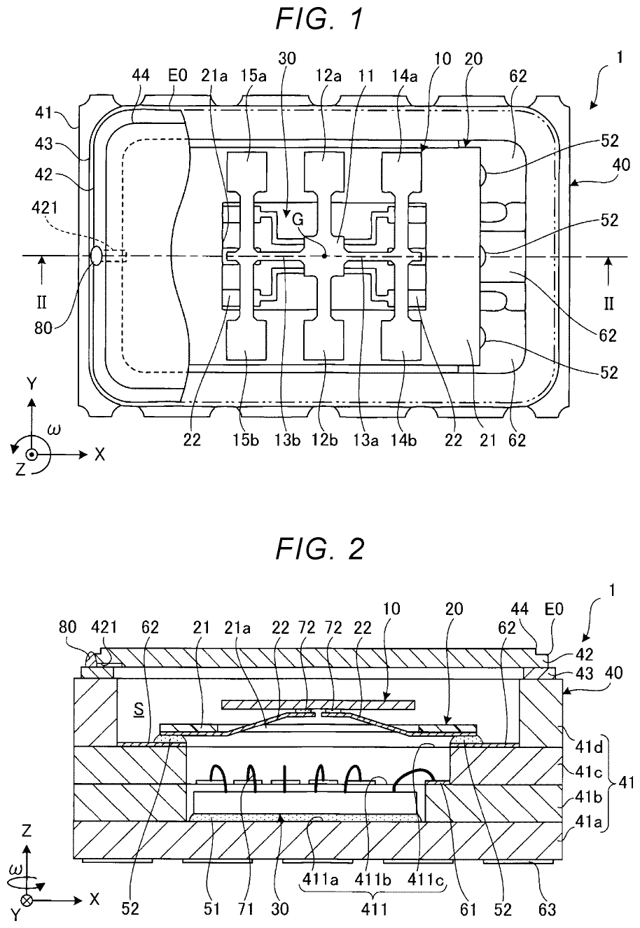

FIG. 1 is a plan view illustrating an electronic device 1 according to a first embodiment. FIG. 2 is a cross-sectional view taken along line II-II in FIG. 1. Hereinafter, for the sake of convenient description, an X axis, a Y axis, and a Z axis that are orthogonal to each other will be used as appropriate. In the following respective figures, arrows representing the axes are appropriately illustrated. A side indicated by the arrow is a +side, and an opposite side thereof is a −side. Further, one or both of a +X direction and a −X direction are simply referred to as an “X direction”, and one or both of a +Y direction and a −Y direction are simply referred to as a “Y direction”, and one or both of a +Z direction and a −Z direction are simply referred to as a “Z direction”. Here, the Z direction is a thickness direction of a plate-shaped lid 42 described below. Viewing from the −Z direction or the +Z direction is called a “plan view”.

The electronic device 1 illustrated in FIGS. 1 and 2 is a vibration type gyro sensor that detects the angular velocity co around the Z axis. The electronic device 1 includes the vibrator elements 10, a support member 20, a circuit element 30, and a package 40. Each of the vibrator elements 10, the support member 20, and the circuit element 30 is an example of an electronic component and is contained in the package 40. Here, the vibrator element 10 is supported by the package 40 via the support member 20. Hereinafter, each unit of the electronic device 1 will be briefly described in sequence.

The vibrator element 10 illustrated in FIGS. 1 and 2 is a sensor element made of a piezoelectric material. An example of the piezoelectric material includes a piezoelectric material such as quartz crystal, lithium tantalate, or lithium niobate. Among these, it is preferable to use the quartz crystal as a configuration material of the vibrator element 10. In this case, frequency-temperature characteristics of the vibrator element 10 can be improved as compared with a case where other piezoelectric materials are used. Hereinafter, a case where the vibrator element 10 is made of the quartz crystal will be described. The X-axis, the Y-axis, and the Z-axis illustrated in the respective figures correspond to an electric axis, a mechanical axis, and an optical axis, respectively, which are crystal axes of quartz crystal configuring the vibrator element 10. In FIGS. 1 and 2, illustration of an electrode provided on a surface of the vibrator element 10 is omitted.

The vibrator element 10 has a so-called double T-type structure. Specifically, the vibrator element 10 includes a base portion 11, a first detection arm 12a and a second detection arm 12b extending from the base portion 11 in the +Y direction and the -Y direction, a first connection arm 13a and a second connection arm 13b extending from the base portion 11 in the +X direction and the −X direction, a first drive arm 14a and a first drive arm 14b extending from the first connection arm 13a in the +Y direction and the −Y direction, and a second drive arm 15a and a second drive arm 15b extending from the second connection arm 13b in the +Y direction and the −Y direction. A shape of each unit of the vibrator element 10 is not limited to the shape illustrated in FIG. 1. For example, each arm of the vibrator element 10 may be appropriately provided with a groove or a hole that opens in the Z direction along a direction in which the arm extends. Further, a width of each arm may be constant.

Although not illustrated, the first drive arm 14a, the first drive arm 14b, the second drive arm 15a, and the second drive arm 15b are provided with a pair of drive electrodes that make the respective drive arms perform flexural vibration in the X direction. Further, although not illustrated, the first detection arm 12a and the second detection arm 12b are provided with a pair of detection electrodes for detecting charges generated by flexural vibration in the X direction of each of the detection arms. Further, the base portion 11 is provided with a plurality of terminals that are electrically connected to the pair of drive electrodes and the pair of detection electrodes. Configuration materials of the above-described drive electrode, detection electrode, and terminal are not limited in particular, and an example thereof includes a metal material such as gold (Au) , chromium (Cr) , or titanium (Ti).

Hereinafter, detection of the angular velocity ω will be briefly described by using the vibrator element 10, and first, an alternating voltage is applied between a pair of drive electrodes (not illustrated) as a drive signal. Then, the first drive arm 14a and the second drive arm 15a perform the flexural vibration in opposite side in the X direction and are in the same phase with the first drive arm 14a and the second drive arm 15a, and the first drive arm 14b and the second drive arm 15b perform the flexural vibration in opposite sides in the X direction. At this time, when no angular velocity is applied to the vibrator element 10, the first drive arms 14a and 14b and the second drive arms 15a and 15b vibrate symmetrically with respect to a YZ plane passing through the center of gravity G of the vibrator element 10, and thereby, the base portion 11, the first connection arm 13a, the second connection arm 13b, the first detection arm 12a, and the second detection arm 12b hardly vibrate.

When the angular velocity co around the Z axis is applied to the vibrator element 10 in a state where the first drive arms 14a and 14b and the second drive arms 15a and 15b perform the flexural vibration as described above, a Coriolis force in the Y direction is applied to each of the drive arms. The first connection arm 13a and the second connection arm 13b perform the flexural vibration in opposite side in the Y direction due to the Coriolis force. According to this, the flexural vibrations of the first detection arm 12a and the second detection arm 12b in the X direction are excited as detection vibrations so as to cancel the flexural vibration. Electric charges generated between the pair of detection electrodes by the detection vibration are output as a detection signal. The angular velocity co is obtained based on the detection signal. As described above, the angular velocity co can be detected.

The support member 20 illustrated in FIGS. 1 and 2 is a substrate for mounting tape automated bonding (TAB). The support member 20 includes a film 21 and a plurality of wires 22. The film 21 is an insulating material made of a resin material such as polyimide. A device hole 21a is formed at the center of the film 21. The plurality of wires 22 are provided corresponding to a pair of drive electrodes and a pair of detection electrodes (not illustrated) in the vibrator element 10 described above. The plurality of wires 22 are bent and extended from one surface of the film 21 to the other surface side of the film 21 through the device hole 21a. Each of the plurality of wires 22 is connected to the base portion 11 of the above-described vibrator element 10 through a metal bump 72. With this connection, the plurality of wires 22 support the vibrator element 10 in a state of being electrically connected to the pair of drive electrodes and the pair of detection electrodes (not illustrated) in the vibrator element 10.

The circuit element 30 illustrated in FIGS. 1 and 2 is an integrated circuit including a drive circuit that drives the vibrator element 10 and a detection circuit that detects electric charges output from the vibrator element 10. Although not illustrated, the circuit element 30 is provided with a plurality of terminals that output a drive signal for driving the above-described vibrator element 10, and a plurality of terminals that receive a detection signal from the vibrator element 10.

The package 40 illustrated in FIGS. 1 and 2, is a container that contains the vibrator element 10, the support member 20, and the circuit element 30. The package 40 includes a base 41, the lid 42, and a bonding member 43. The base 41 and the lid 42 are bonded to each other via the bonding member 43. As illustrated in FIG. 2, a space S that contains the vibrator element 10, the support member 20, and the circuit element 30 is formed between the base 41 and the lid 42. The space S is, for example, in a reduced pressure state of 10 Pa or less. The space S may be filled with an inert gas such as argon or nitrogen.

The base 41 is a box-shaped member having a concave portion 411. An outer shape of the base 41 in a plan view is substantially rectangular. Although not limited in particular, various ceramics such as aluminum oxide are used as a configuration material of the base 41. In the example illustrated in FIG. 2, the base 41 has a flat substrate 41a, three frame-shaped substrates 41b, 41c, and 41d, which are sequentially stacked in the +Z direction. Although not illustrated, wires made of metal or the like are appropriately provided between the plurality of substrates configuring the base 41. The number of substrates configuring the base 41 is not limited to the example illustrated in FIG. 2 and is random. Further, a shape of the base 41 may be a shape that allows seam welding described below, is not limited to the shape illustrated in FIG. 2, and is random.

A concave portion 411 includes a bottom surface 411a configured by a surface on the +Z direction side of the substrate 41a, a stepped surface 411b configured by a surface on the +Z direction side of the substrate 41b, and a stepped surface 411c configured by a surface on the +Z direction side of the substrate 41c.

The circuit element 30 is fixed to the bottom surface 411a via a fixing member 51 in a state of being fitted inside the substrate 41b. The fixing member 51 is an adhesive formed to include, for example, an epoxy resin or an acrylic resin. A plurality of internal terminals 61 are provided on the stepped surface 411b. The plurality of internal terminals 61 are electrically connected to a plurality of terminals (not illustrated) of the circuit element 30 via a plurality of wires 71. Each of the plurality of wires 71 is configured by, for example, a bonding wire. A plurality of internal terminals 62 are provided on the stepped surface 411c. The plurality of internal terminals 62 are provided corresponding to the plurality of wires 22 of the support member 20 described above.

The plurality of wires 22 of the support member 20 are fixed to the plurality of internal terminals 62 via a plurality of conductive fixing members 52. By the fixing, the plurality of internal terminals 62 are electrically connected to a plurality of a pair of drive electrodes and a pair of detection electrodes (not illustrated) in the vibrator element 10 described above. Each of the plurality of fixing members 52 is made of, for example, solder, silver paste, a conductive adhesive, or the like.

Although not illustrated, the plurality of internal terminals 61 and the plurality of internal terminals 62 are appropriately connected to a plurality of wires provided inside the base 41. Specifically, the plurality of wires include a plurality of wires that connect some of the plurality of internal terminals 61 to the plurality of internal terminals 62, and a plurality of wires that connect the remaining terminals of the plurality of internal terminals 61 to a plurality of external terminals 63 on an outer surface of the base 41. The plurality of external terminals 63 are used when the electronic device 1 is mounted on an external apparatus (not illustrated). The internal terminals 61 and 62 and the external terminals 63 are respectively formed by metal films obtained by plating a metallized layer of, for example, tungsten (W) or the like with a film of nickel (Ni), gold (Au), or the like on.

The lid 42 is a plate-shaped member that has a substantially rectangular outer shape in a plan view and closes an opening of the concave portion 411 of the base 41 described above. A material of the lid 42 may be a material that can be seam-welded to the base 41 or the bonding member 43, and includes metals such as Kovar, 42 alloy, and stainless steel. Further, a surface on the base 41 side in the lid 42 is appropriately plated with a film of, for example, nickel (Ni) or the like. A groove 421 is provided in the surface on the base 41 side of the lid 42 illustrated in FIGS. 1 and 2. The groove 421 allows the inside and the outside of the space S to communicate when the electronic device 1 is manufactured and is used as an exhaust hole when the space S is depressurized. The groove 421 is closed by a sealing portion 80 formed by solidifying one or both of the lid 42 and the bonding member 43 after being melted by energy rays. A shape of the lid 42 will be described in detail below.

The bonding member 43 is a frame-like member that is interposed between the base 41 and the lid 42 and bonds the base 41 to the lid 42. The bonding member 43 is also referred to as a seal ring in general. The bonding member 43 is made of, for example, a metal such as Kovar, 42 alloy, or stainless steel. Further, a surface of the bonding member 43 is appropriately plated with, for example, a film of nickel (Ni), gold (Au) or the like. The above-described bonding member 43 is airtightly bonded to the base 41 by soldering using a silver solder or the like. Further, the bonding member 43 is airtightly bonded to the lid 42 by seam welding. By the bonding, the base 41 and the lid 42 are bonded together via the bonding member 43. Instead of the bonding member 43, a metal film formed by plating a metallized layer of tungsten (W) or the like with a film of nickel (Ni) , gold (Au) , or the like may be provided on the base 41.

The above is a brief description of each unit of the electronic device 1. In the electronic device 1 described above, although the base 41 and the lid 42 are bonded by seam welding, a stepped surface 44 is provided on a surface opposite to the base 41 in the lid 42 so as to reduce welding unevenness in the seam welding. Hereinafter, a shape of the lid 42 will be described in detail. Since the actual lid 42 is slightly deformed due to pressurization and melting by the seam welding, the shape is slightly different before and after the seam welding. Hereinafter, description will be made by assuming that the shape of the lid 42 is the same before and after the seam welding. However, actually, it can be said that the shape of the lid 42 is substantially the same before and after the seam welding, except that a slight mark due to contact with a roller electrode 201 described below is formed by the seam welding.

### A1-2. Shape of Lid

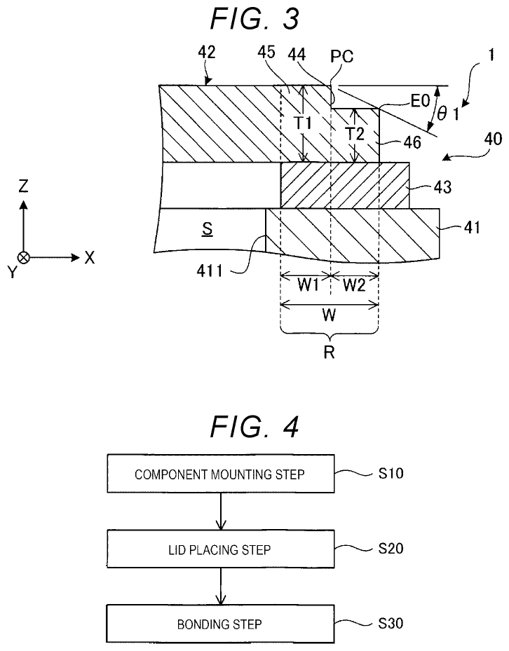

FIG. 3 is a cross-sectional view illustrating the shape of the lid 42 according to the first embodiment. As illustrated in FIG. 3, the lid 42 is bonded to the base 41 in a region R. The lid 42 includes a first portion 45 and a second portion 46 thinner than the first portion 45 in a portion overlapping the region R in a plan view. The first portion 45 has a constant thickness T1. The second portion 46 includes an outer edge E0 of the lid 42 and is a portion between the outer edge E0 and the first portion 45. The second portion 46 has a constant thickness T2 smaller than the thickness T1.

A stepped surface 44 due to a difference between the thicknesses T1 and T2 is provided on a surface of the lid 42 opposite to the base 41 in the first portion 45 and the second portion 46. That is, the surface of the lid 42 opposite to the base 41 has the stepped surface 44 of a stepped shape that approaches the base 41 toward the outer edge E0 of the lid 42 in a portion overlapping the region R in a plan view. As described above, the surface of the lid 42 opposite to the base 41 has a shape in which a distance from the base 41 is maximum inside the lid 42 more than at the outer edge E0 of the lid 42 in a portion overlapping the region R where the base 41 and the lid 42 are welded in a plan view. The maximum distance in the present embodiment is equal to the thickness T1.

The region R is a region where the base 41 and the lid 42 are welded. Further, the region R is a region where the lid 42 and the bonding member 43 overlap in a plan view and can also be said to be a region where the base 41 and the lid 42 are to be welded before welding. In the present embodiment, the outer edge E0 overlaps the region R in a plan view. The outer edge E0 may not overlap the region R in a plan view.

In the present embodiment, the stepped surface 44 is provided over an entire circumference of the lid 42. However, the stepped surface 44 may not be provided over the entire circumference of the lid 42, and may be missed, for example, at a portion corresponding to the above-described groove 421.

A dimension of each part of the first portion 45 and the second portion 46 is designed suitably such that the roller electrode 201 used for the seam welding described below may contact a corner of the stepped surface 44 in a contact position PC without being in contact with the outer edge E0. Here, the thickness T1 of the first portion 45 is not limited in particular and is in a range, for example, more than or equal to 50 μm and less than or equal to 200 μm. The thickness T2 of the second portion 46 is not limited in particular and is in a range, for example, more than or equal to 40 μm and less than or equal to 150 μm. A difference D between the thickness T1 and the thickness T2 is not limited in particular and is in a range, for example, more than or equal to 10 μm and less than or equal to 50 μm. A width W1 of the first portion 45 and a width W2 of the second portion 46 are not limited in particular and are in a range, for example, more than or equal to 30 μm and less than or equal to 150 μm.

The electronic device 1 described above includes the vibrator element 10 that is an electronic component, the support member 20, and the circuit element 30, the base 41 on which the vibrator element 10, the support member 20, and the circuit element 30 are mounted, and the lid 42 that is welded to the base 41 in a state of containing the vibrator element piece 10, the support member 20, and the circuit element 30. Further, a surface of the lid 42 opposite to the base 41 has a shape in which a distance from the base 41 is maximum inside the lid 42 more than at the outer edge E0 in a portion overlapping the region R where the base 41 and the lid are welded in a plan view. Accordingly, it is possible to reduce welding unevenness between the base 41 and the lid 42 when performing the seam welding described below.

### A1-3. Electronic Device Manufacturing Method

FIG. 4 is a diagram illustrating a flow of a method of manufacturing the electronic device 1. As illustrated in FIG. 4, the method of manufacturing the electronic device 1 includes a component mounting step S10, a lid placing step S20, and a bonding step S30. Hereinafter, each step will be described sequentially.

A1-3a. Component Mounting Step S10

In the component mounting step S10, first, each component configuring the electronic device 1 is prepared. Specifically, the vibrator element piece 10, the support member 20, the circuit element 30, the base 41, the lid 42, and the bonding member 43 are prepared. The vibrator element 10, the support member 20, the circuit element 30, the base 41, and the bonding member 43 are each manufactured by, for example, a known method. A method of manufacturing the lid 42 is not limited in particular, and includes, for example, a method of etching a metal plate and a method of pressing the metal plate, but it is preferable to use the method of pressing the metal plate. In this case, there is an advantage that it is easy to achieve both the dimensional accuracy of the lid 42 and productivity. This point will be specifically described below.

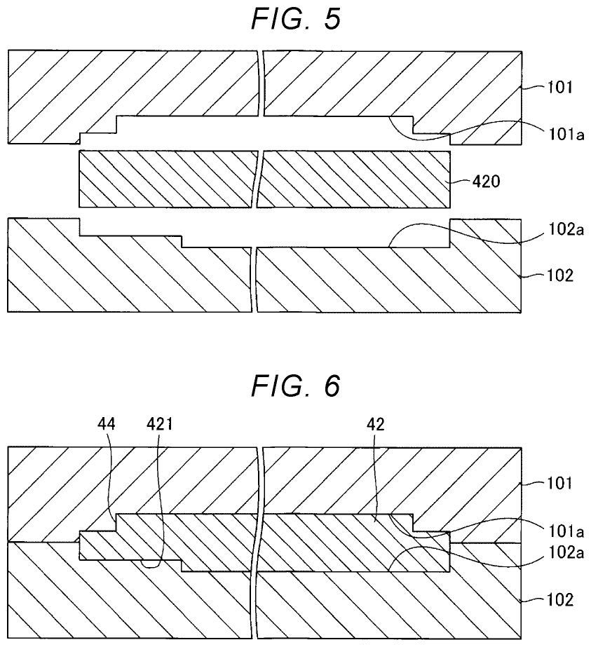

FIG. 5 is a cross-sectional view illustrating a state before pressing when the lid 42 is manufactured by pressing. As illustrated in FIG. 5, a flat metal plate 420 is first installed between a pair of molds 101 and 102. The metal plate 420 is a plate member formed of a metal such as Kovar, 42 alloy, stainless steel, or the like. The mold 101 has a surface 101a that forms one surface of the lid 42. The surface 101a includes a portion having a shape corresponding to the stepped surface 44 described above. The mold 102 has a surface 102a forming another surface of the lid 42. The surface 102a has a portion forming a shape corresponding to the groove 421 described above.

FIG. 6 is a cross-sectional view illustrating a state when pressing when the lid 42 is manufactured by pressing. As illustrated in FIG. 6, the lid 42 is obtained by pressure-forming the metal plate 420 by using a pair of molds 101 and 102. The above-described pressing has an advantage that the shape of the lid 42 in a plan view, the groove 421, and the stepped surface 44 are formed collectively.

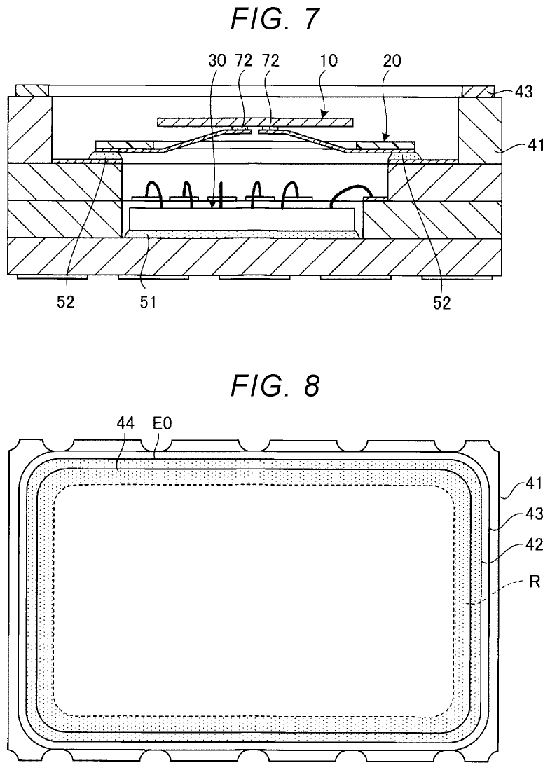

FIG. 7 is a cross-sectional view illustrating an arrangement state of each member in the component mounting step S10. In the component mounting step S10, the vibrator element 10, the support member 20, and the circuit element 30 are mounted on the base 41 as illustrated in FIG. 7. More specifically, for example, the vibrator element 10 is fixed previously to the support member 20 by the metal bumps 72, the circuit element 30 is fixed to the base 41 by the fixing member 51, and thereafter the support member 20 is fixed to each of the vibrator elements 10 by the fixing member 52. Further, the bonding member 43 is bonded to the base 41 by soldering or the like.

A1-3b. Lid placing step S20

FIG. 8 is a plan view illustrating a positional relationship between the base 41 and the lid 42 in the lid placing step S20. In the lid placing step S20, the lid 42 is placed on the base 41 via the bonding member 43 as illustrated in FIG. 8. Here, a corner of the stepped surface 44 of the lid 42 is located between an inner circumference and an outer circumference of the region R where the lid 42 and the bonding member 43 overlap in a plan view. The outer edge E0 of the lid 42 is also located between the inner circumference and the outer circumference of the region R where the lid 42 and the bonding member 43 overlap in a plan view. In FIG. 8, the region R is illustrated in a dot pattern.

A1-3c. Bonding step S30

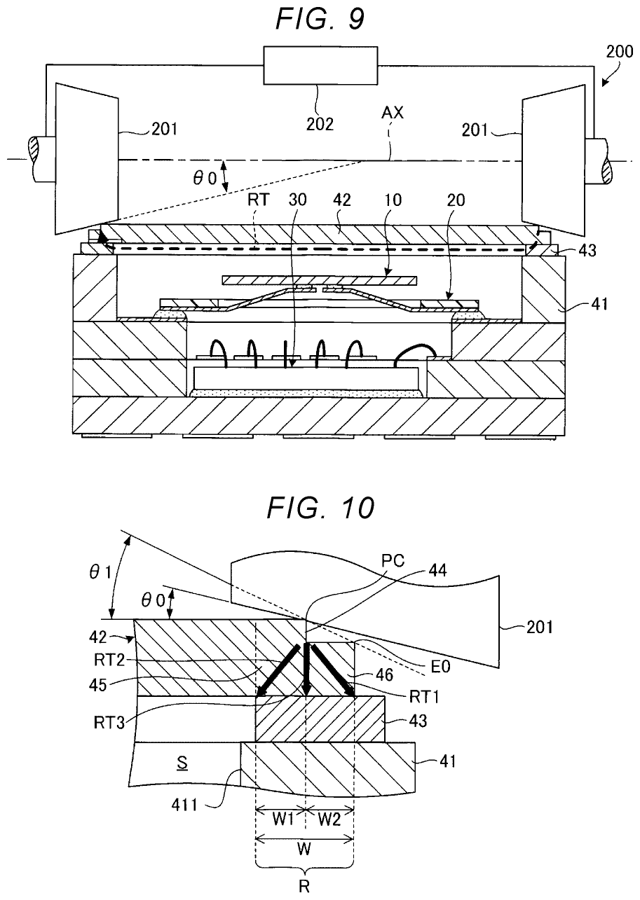

FIG. 9 is a cross-sectional view illustrating an outline of the seam welding in the bonding step S30. As illustrated in FIG. 9, during the bonding step S30, the base 41 and the lid 42 are bonded by the seam welding via the bonding member 43 by using a seam welding machine 200. The seam welding machine 200 includes a pair of roller electrodes 201 and a power source 202 that allows a current to flow between the electrodes.

The pair of roller electrodes 201 can rotate around the same axis line AX and are spaced apart from each other in a direction parallel to the axis line AX. An interval is determined according to a length of the lid 42 in the X direction or the Y direction. Each of the pair of roller electrodes 201 has a circular shape in a cross section perpendicular to the axis line AX, and has a shape in which an outer diameter becomes smaller at a predetermined taper angle θ0 when going between the electrodes. The taper angle θ0 is not limited in particular, and is in a range, for example, more than or equal to 5° and less than or equal to 25°.

The pair of roller electrodes 201 is in pressure contact with the lid 42 by a pressure mechanism (not illustrated. The pair of roller electrodes 201 travels at a predetermined speed along a pair of sides of the lid 42 parallel to each other in a plan view while rotating around the axis lines. At this time, the power source 202 causes Joule heat to be generated in the bonding member 43 by causing a current to flow between the pair of roller electrodes 201 via the lid 42 and the bonding member 43 along a path RT illustrated in FIG. 9. By melting the lid 42 and the bonding member 43 by using the Joule heat, the lid 42 and the bonding member 43 are bonded together. In the same manner as described above, the lid 42 and the bonding member 43 are also bonded to the remaining pair of sides of the lid 42 parallel to each other in a plan view.

FIG. 10 is a view illustrating a state of a current flowing from the lid 42 toward the base 41 during the seam welding in the first embodiment. As illustrated in FIG. 10, a stepped surface 44 is provided on the surface of the lid 42 opposite to the base 41. Here, when viewed from a cross section perpendicular to the direction in which the outer edge E0 extends, an angle θ1 formed by a line segment coupling the outer edge E0 to the corner of the stepped surface 44 and a line segment perpendicular to the thickness direction of the lid 42 is larger than the taper angle θ0 of the roller electrode 201. Accordingly, the roller electrode 201 does not come into contact with the outer edge E0 but comes into contact with the corner of the stepped surface 44 at the contact position PC. Here, a difference between the angle θ1 and the taper angle θ0 is not limited in particular, and is preferably within a range, for example, more than or equal to 5° and less than or equal to 20° from a viewpoint of ease and the like of manufacturing the lid 42, and it is more preferably to be in a range more than or equal to 10° and less than or equal to 15°.

A ratio between the width W2 and a width W of the region R is preferably in a range more than or equal to 0.4 and less than or equal to 0.6. If the ratio is within the range, the roller electrode 201 can come into contact with the lid 42 near the center in a width direction of the region R. As a result, as illustrated in FIG. 10, it is possible to extremely reduce a difference between a length of a path RT2 of a current flowing from the roller electrode 201 toward an inner circumference of the region R and a length of a path RT1 of a current flowing toward an outer circumference of the region R. The width W is a length of the region R in the direction along an axis of the roller electrode 201. The width W2 is a distance between the outer edge E0 of the lid 42 in the direction along the axis of the roller electrode 201 and the contact position PC. In the case illustrated in FIG. 10, a length of a path RT3 of the current flowing from the roller electrode 201 toward the center of the region R is slightly smaller than the length of each of the paths RT1 and RT2.

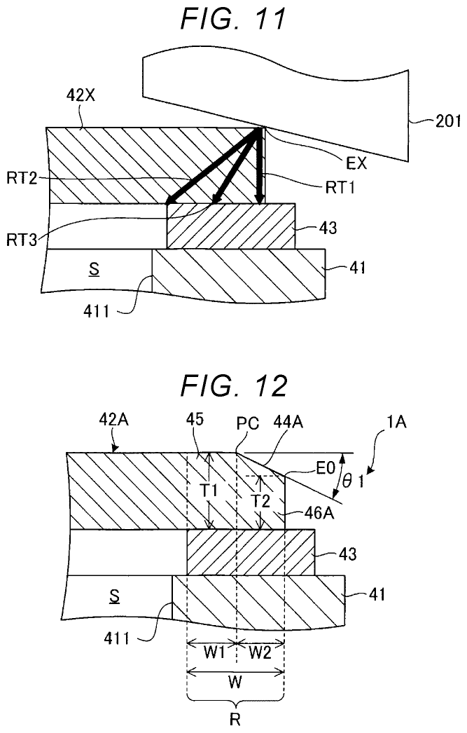

FIG. 11 is a diagram illustrating a state of a current flowing from a lid 42X toward the base 41 during seam welding of related art. In the related art, since a thickness of the lid 42X is uniform, the roller electrode 201 is in contact with an outer edge EX of the lid 42X. Accordingly, as illustrated in FIG. 11, the difference between the length of the path RT2 of a current flowing from the roller electrode 201 toward the inner peripheral edge of the region R and the length of the path RT1 of a current flowing toward the outer peripheral edge of the region R is extremely large. In the case illustrated in FIG. 11, the length of the path RT2 is longer than the length of the path RT1. In the case illustrated in FIG. 11, the length of the path RT3 of a current flowing from the roller electrode 201 toward the center of the region R is a length between the length of the path RT1 and the length of the path RT2.

After the above-described seam welding, in the present embodiment, the space S is depressurized by using the groove 421 of the lid 42 as an exhaust hole. Thereafter, the groove 421 of the lid 42 is closed by using an energy ray such as laser light or an electron beam in a depressurization atmosphere or an inert gas atmosphere. Thereby, the electronic device 1 is obtained.

In the method of manufacturing the electronic device described above, the vibrator element 10 which is an electronic component, the support member 20, and the circuit element 30 are mounted on the base 41, the lid 42 is placed on the base 41, and the base 41 and the lid 42 are bonded by seam welding. In the seam welding, the roller electrode 201 and the lid 42 are brought into contact with each other at the contact position PC that overlaps the region R to be welded between the base 41 and the lid 42 inside the outer edge E0 of the lid 42 in a plan view. Accordingly, compared with the case where the roller electrode 201 comes into contact with the outer edge E0 of the lid 42, the difference between the length of the path RT2 of the current flowing from the roller electrode 201 toward the inner peripheral edge of the region R and the length of the path RT1 of the current flowing toward the outer peripheral edge of the region R can be reduced. As a result, it is possible to reduce a variation in current in the region R to be welded and to reduce welding unevenness between the base 41 and the lid 42.

In the present embodiment, a surface of the lid 42 opposite to the base 41 includes the stepped surface 44 having a stepped shape that approaches the base 41 toward the outer edge E0 of the lid 42 in a portion overlapping the region R in a plan view. According to the lid 42 including the stepped surface 44, when the lid 42 is manufactured by pressing, there is an advantage that the lid 42 can be easily and accurately formed together with other portions of the lid 42.

### A2. Second Embodiment

Next, a second embodiment will be described. The present embodiment is the same as the first embodiment described above except that the lid has a different shape. In the following description, the second embodiment will be described by focusing on a difference from the first embodiment described above, and description on the same matter will be omitted. Further, in the figure used for description of the second embodiment, the same symbol or reference numeral is attached to the same configuration as in the first embodiment described above.

FIG. 12 is a cross cross-sectional view illustrating a shape of a lid 42A according to the second embodiment. The lid 42A used for an electronic device 1A illustrated in FIG. 12 includes the first portion 45 and a second portion 46A thinner than the first portion 45 in a portion overlapping the region R in a plan view. The second portion 46A has a shape in which a thickness continuously decreases from the first portion 45 toward the outer edge E0 of the lid 42A. Here, a surface of the second portion 46A opposite to the base 41 is a flat inclined surface 44A that is inclined at an angle θ1 with respect to a plane perpendicular to a thickness direction of the lid 42A.

As described above, the surface of the lid 42A opposite to the base 41 has the inclined surface 44A that approaches the base 41 toward the outer edge E0 of the lid 42A in a portion overlapping the region R in a plan view. The inclined surface 44A has an advantage that, when being manufactured by pressing, the lid 42A can be easily and highly accurately formed together with other portions of the lid 42A. In the present embodiment, since there is no step difference between the first portion 45 and the second portion 46A, there is an advantage that, when the lid 42A is manufactured by pressing, releasability is better than the releasability in the first embodiment.

In the lid 42A having the above-described configuration, an end of the inclined surface 44A on the first portion 45 side is in contact with the roller electrode 201 as the contact position PC during seam welding. The second embodiment described above also provides the same effects as in the first embodiment described above.

Here, the angle θ1 formed by a plane orthogonal to the thickness direction of the base 41 and the inclined surface 44A is larger than the taper angle θ0 that is an angle formed by the outer peripheral surface of the roller electrode 201 and a central axis of the roller electrode 201. Accordingly, it is possible to prevent the roller electrode 201 and the outer edge E0 of the lid 42A from coming into contact with each other.

### A3. Third Embodiment

Next, a third embodiment will be described. The present embodiment is the same as the first embodiment described above except that the lid has a different shape. In the following description, the third embodiment will be described by focusing on a difference from the first embodiment described above, and description on the same matters will be omitted. Further, in the figure used for description of the third embodiment, the same symbol or reference numeral is attached to the same configuration as in the first embodiment described above.

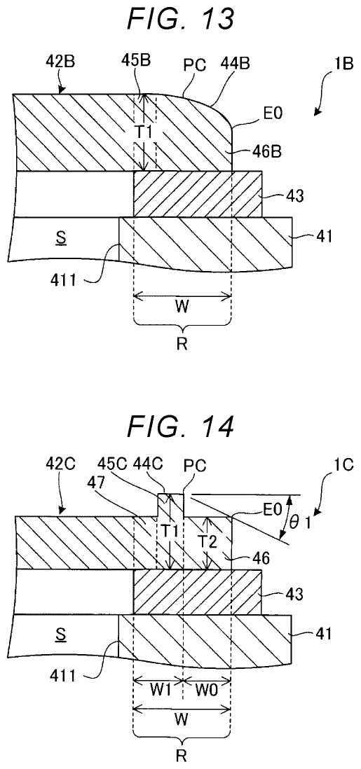

FIG. 13 is a cross cross-sectional view illustrating a shape of a lid 42B according to the third embodiment. The lid 42B used for an electronic device 1B illustrated in FIG. 13 includes a first portion 45B and a second portion 46B thinner than the first portion 45B in a portion overlapping the region R in a plan view. The first portion 45B has a constant thickness T1. The second portion 46B includes the outer edge E0 of the lid 42B and is a portion between the outer edge E0 and the first portion 45B. The second portion 46B has a shape in which a thickness continuously decreases from the first portion 45B toward the outer edge E0 of the lid 42B. Here, a surface of the second portion 46B opposite to the base 41 is a curved surface 44B of a projection shape that is inclined with respect to a plane perpendicular to a thickness direction of the lid 42A.

As described above, a surface of the lid 42B opposite to the base 41 has the curved surface 44B that approaches the base 41 toward the outer edge E0 of the lid 42B in a portion overlapping the region R in a plan view. The curved surface 44B has an advantage that, when being manufactured by pressing, the lid 42B can be easily and accurately formed together with other portions of the lid 42B. In the present embodiment, since the curved surface 44B is a projection surface, there is also an advantage that a variation in a contact area between the roller electrode 201 and the lid 42B can be reduced.

In the lid 42B having the above-described configuration, the curved surface 44B is in contact with the roller electrode 201 during seam welding. The third embodiment described above also provides the same effects as in the first embodiment described above.

### A4. Fourth Embodiment

Next, a fourth embodiment will be described. The present embodiment is the same as the first embodiment described above except that the lid has a different shape. In the following description, the fourth embodiment will be described by focusing on a difference from the first embodiment described above, and description on the same matters will be omitted. Further, in the figure used for description of the fourth embodiment, the same symbol or reference numeral is attached to the same configuration as in the first embodiment described above.

FIG. 14 is a cross cross-sectional view illustrating a shape of a lid 42C according to the fourth embodiment. The lid 42C used for an electronic device 1C illustrated in FIG. 14 includes a first portion 45C and the second portion 46 and a third portion 47 thinner than the first portion 45C in a portion overlapping the region R in a plan view. The first portion 45C is provided between the second portion 46 and the third portion 47. Thicknesses of the second portion 46 and the third portion 47 may be the same or different. Here, a projection portion 44C by the first portion 45C is provided in a surface of the lid 42c opposite to the base 41.

As described above, the surface of the lid 42C opposite to the base 41 has a projection portion 44C provided along the outer edge E0 of the lid 42C on the inner side more than on the outer edge E0 of the lid 42C in a portion overlapping the region R in a plan view. The projection portion 44C has an advantage that a variation of the contact position PC between the roller electrode 201 and the lid 42C can be easily reduced. A width of the projection portion 44C is not limited in particular and is preferably in a range more than or equal to 1/10 times and less than or equal to ½ times the width W of the region R from a viewpoint of suitably obtaining the advantage.

In the lid 42C having the above-described configuration, the projection portion 44C is in contact with the roller electrode 201 during seam welding. The fourth embodiment described above also provides the same effects as in the first embodiment described above.

### B. Electronic Apparatus

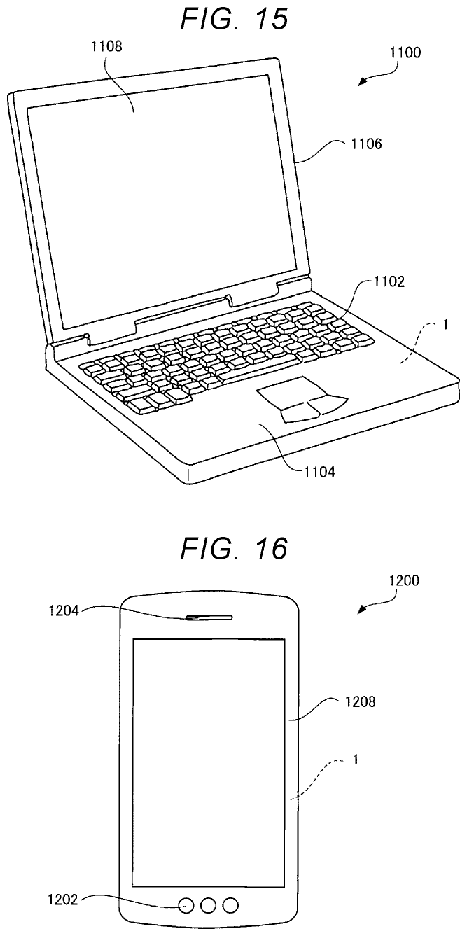

FIG. 15 is a perspective view schematically illustrating a configuration of a mobile type or notebook type personal computer 1100 that is an example of an electronic apparatus. In this figure, the personal computer 1100 includes a main body portion 1104 having a keyboard 1102 and a display unit 1106 having a display portion 1108. The display unit 1106 is rotatably supported to the main body portion 1104 via a hinge structure. The above-described electronic device 1 that functions as a gyro sensor is embedded in the personal computer 1100 described above.

FIG. 16 is a plan view schematically illustrating a configuration of a smartphone 1200 that is an example of the electronic apparatus. In this figure, the smartphone 1200 includes a plurality of operation buttons 1202, an earpiece 1204 and a mouthpiece (not illustrated), and a display portion 1208 disposed between the operation buttons 1202 and the earpiece 1204. The above-described electronic device 1 that functions as a gyro sensor is embedded in the smartphone 1200 described above.

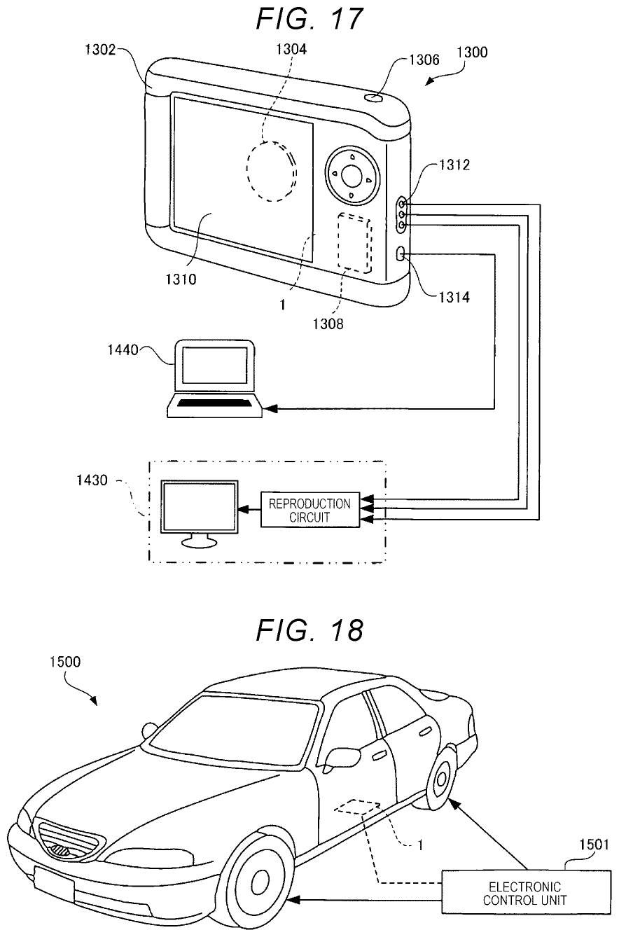

FIG. 17 is a perspective view schematically illustrating a configuration of a digital still camera 1300 which is an example of the electronic apparatus. In this figure, a connection with an external device is also simply illustrated. The digital still camera 1300 generates an imaging signal (image signal) by photoelectrically converting an optical image of an object by using an imaging element such as a charge coupled device (CCD).

A display portion 1310 that performs display based on an imaging signal from the CCD is provided on the back of a case 1302 in the digital still camera 1300. The display portion 1310 functions as a viewfinder that displays an object as an electronic image. A light receiving unit 1304 including an optical lens (imaging optical system), a CCD, and the like is provided on a front side (a back side in the drawing) of the case 1302.

If a photographer confirms an object image displayed on the display portion 1310 and presses a shutter button 1306, a CCD imaging signal at that time is transferred to the memory 1308 to be stored therein. In the digital still camera 1300, a video signal output terminal 1312 and an input/output terminal 1314 for data communication are provided on a side surface of the case 1302. As illustrated in the figure, a television monitor 1430 is connected to a video signal output terminal 1312, and a personal computer 1440 is connected to an input/output terminal 1314 for data communication as necessary. Further, the imaging signal stored in the memory 1308 is output to the television monitor 1430 or the personal computer 1440 by a predetermined operation. The above-described electronic device 1 that functions as a gyro sensor is embedded in the digital still camera 1300 described above.

Since the above-described electronic apparatus includes the electronic device 1, characteristics of the electronic apparatus can be improved by a high reliability of the electronic device 1.

In addition to the personal computer, the smartphone, and the digital still camera described above, for example, a mobile phone other than the smartphone, a tablet terminal, a timepiece, a car body posture detection device, a pointing device, a head-mounted display, an ink jet printer, a laptop personal computer, a television, a video camera, a video tape recorder, a navigation device, a pager, an electronic notebook, an electronic dictionary, a calculator, an electronic game device, a game controller, a word processor, a workstation, a video phone, a TV monitor for security, electronic binoculars, a point of sale system (POS) terminal, an electronic thermometer, a blood pressure meter, a blood glucose meter, an electrocardiogram measurement device, an ultrasonic diagnosis device, an electronic endoscope, a fish detector, various measurement apparatuses, various measurement instruments, a flight simulator, and the like can be used as an electronic apparatus in which the electronic device 1 is mounted.

### C. Vehicle

FIG. 18 is a perspective view schematically illustrating an automobile 1500 which is an example of a vehicle. In this figure, the above-described electronic device 1 that functions as a gyro sensor is embedded in the automobile 1500. The electronic device 1 can be widely applied to an electronic control unit (ECU) 1501 such as a keyless entry, an immobilizer, a navigation system, an air conditioner, an antilock brake system (ABS), an airbag, a tire pressure monitoring system (TPMS), an engine control, a battery monitor for a hybrid car or an electric car, a car body posture control system, or the like. In addition to the automobile, for example, a vehicle, an aircraft, a rocket, a ship, and the like can be used as the vehicle in which the electronic apparatus is mounted.

Since the above-described vehicle includes the electronic device 1, characteristics of the vehicle can be improved by a high reliability of the electronic device 1.

### D. Modification Example

As described above, the electronic manufacturing method, the electronic device, the electronic apparatus, and the vehicle according to the present disclosure are described based on the illustrated embodiments, and the present disclosure is not limited to these. Further, configurations of the respective units of the present disclosure can be substituted by any structure which exhibits the same function of the embodiment described above, and any configuration can also be added thereto. Further, in the present disclosure, any configurations of the respective embodiments described above may be combined with each other.

Although a case where the vibrator element is made of a piezoelectric material is exemplified in the above-described embodiment, the configuration material of the vibrator element is not limited to the exemplification and may be, for example, a non-piezoelectric material such as silicon or quartz. In this case, for example, the piezoelectric element may be provided on a base made of the non-piezoelectric material. Further, when the vibrator element is made of silicon, the vibrator element with high dimensional accuracy can be manufactured at a relatively low cost by using a known fine processing technique such as etching.

Although a case where a piezoelectric drive method is used as a method of driving the vibrator element is exemplified in the above-described embodiment, the method of driving the vibrator element is not limited to the exemplification and may be, for example, an electrostatic drive method or an electromagnetic drive method. Likewise, although a case where a piezoelectric detection method is used as a method of detecting the vibrator element is exemplified in the above-described embodiment, the method of detecting the vibrator element is not limited to this and may be, for example, a capacitance detection method, a piezoresistance detection method or an electromagnetic detection method.

Furthermore, although a case where the vibrator element is a double T-type sensor element is exemplified in the above-described embodiment, the vibrator element is not limited to the exemplification and may be, for example, an H tuning fork type sensor element or another sensor element of a tuning fork type or may be a vibrator element or the like for oscillator.

Further, although a case where a vibrator element, a support member, and a circuit element are used as electronic components to be mounted on a base is exemplified in the above-described embodiment, the electronic component may be an electronic component other than the exemplification, and any one or more electronic components may be mounted on the base. However, in the vibrator element in the above-described embodiment, airtightness in the package has an extremely large influence on characteristics of the electronic device compared to other electronic components, and thus, effects of the present disclosure are remarkably exhibited.

Furthermore, although a configuration in which a base has a box shape and a lid has a plate shape is illustrated in the above-described embodiment, the present disclosure is not limited to the configuration. For example, the base may have a plate shape and the lid may have a box shape or a hat shape.

Further, although a case where a groove used as an exhaust hole is provided in a lid is exemplified in the above-described embodiment, the groove may be omitted. In this case, a hole used as the exhaust hole may be provided in the base. The hole is closed with a sealing material formed of, for example, an Au—Ge alloy or the like.

What is claimed is:

1. An electronic device manufacturing method comprising:
mounting an electronic component on a base;
placing a lid on the base; and
bringing a roller electrode to come into contact with the lid at a contact position overlapping a region where the base and the lid are welded inside an outer edge of the lid in a plan view, and bonding the lid to the base by seam welding.

2. The electronic device manufacturing method according to claim 1, wherein
a ratio of a distance between the outer edge of the lid and the contact position in a direction along an axis of the roller electrode to a length of the region in the direction along the axis of the roller electrode is in a range more than or equal to 0.4 and less than or equal to 0.6.

3. The electronic device manufacturing method according to claim 1, wherein
a surface of the lid opposite to the base forms a shape such that a distance from the base is the maximum inside the outer edge of the lid in a portion overlapping the region in a plan view.

4. The electronic device manufacturing method according to claim 1, wherein
a surface of the lid opposite to the base has a stepped surface having a stepped shape approaching the base toward the outer edge of the lid in a portion overlapping the region in a plan view.

5. The electronic device manufacturing method according to claim 4, wherein
when viewed from a cross section perpendicular to a direction in which the outer edge of the lid extends, an angle formed by a line segment coupling the outer edge of the lid to a corner of the stepped surface and a line segment perpendicular to a thickness direction of the lid is greater than an angle formed by an outer peripheral surface of the roller electrode and a central axis of the roller electrode.

6. The electronic device manufacturing method according to claim 1, wherein
a surface of the lid opposite to the base has an inclined surface approaching the base toward the outer edge of the lid in a portion overlapping the region in a plan view.

7. The electronic device manufacturing method according to claim 6, wherein
an angle formed by a plane perpendicular to a thickness direction of the base and the inclined surface is greater than an angle formed by an outer peripheral surface of the roller electrode and a central axis of the roller electrode.

8. The electronic device manufacturing method according to claim 1, wherein
a surface of the lid opposite to the base has a curved surface approaching the base toward the outer edge of the lid in a portion overlapping the region in a plan view.

9. The electronic device manufacturing method according to claim 1, wherein
a surface of the lid opposite to the base has a projection portion provided along the outer edge of the lid inside the outer edge of the lid in a portion overlapping the region in a plan view.

10. An electronic device comprising:
an electronic component;
a base on which the electronic component is mounted; and
a lid welded to the base in a state in which the electronic component is contained between the base and the lid, wherein
a surface of the lid opposite to the base forms a shape such that a distance from the base is the maximum inside an outer edge of the lid in a portion overlapping a region where the base and the lid are welded in a plan view.

11. The electronic device according to claim 10, wherein
a surface of the lid opposite to the base has a stepped surface having a stepped shape approaching the base toward the outer edge of the lid in a portion overlapping the region in a plan view.

12. The electronic device according to claim 10, wherein
a surface of the lid opposite to the base has an inclined surface approaching the base toward the outer edge of the lid in a portion overlapping the region in a plan view.

13. The electronic device according to claim 10, wherein
a surface of the lid opposite to the base has a curved surface approaching the base toward the outer edge of the lid in a portion overlapping the region in a plan view.

14. The electronic device according to claim 10, wherein
a surface of the lid opposite to the base has a projection portion provided along the outer edge of the lid inside the outer edge of the lid in a portion overlapping the region in a plan view.

15. The electronic device according to claim 10, wherein the electronic component is a vibrator element.

16. An electronic apparatus comprising:
the electronic device according to claim 10.

17. A vehicle comprising:
the electronic device according to claim 10.
